(19) United States
(12) Patent Application Publication
(10) Pub. No.: US 2022/0026257 A1
(43) Pub. Date: Jan. 27, 2022

(54) METHOD FOR FILL LEVEL MEASUREMENT

(71) Applicant: Endress+Hauser SE+Co. KG, Maulburg (DE)

(72) Inventors: Manuel Sautermeister, Schopfheim (DE); Daniel Müller, Inzlingen (DE); Eric Birgel, Schopfheim (DE); Thomas Blödt, Steinen (DE); Klaus Pankratz, Kandern (DE); Dirk Dohse, Freiburg (DE)

(21) Appl. No.: 17/312,229

(22) PCT Filed: Nov. 11, 2019
(86) PCT No.: PCT/EP2019/080805

§ 371 Date: Jun. 9, 2021

(30) Foreign Application Priority Data
Dec. 10, 2018 (DE) 10 2018 131 604.6

(51) Int. Cl. G01F 23/296; G01F 23/292; G01F 25/00

(52) U.S. Cl. CPC G01F 23/296; G01F 25/0061; G01F 23/292

(57) ABSTRACT

Disclosed is a method for measuring a fill level of a fill substance in a container. The method includes: transmitting a first signal toward the fill substance; receiving a first received signal after reflection of the first signal in the container; transmitting a second signal toward the fill substance, wherein the second signal has at least one defined property deviating from the first signal; receiving a second received signal after reflection of the second signal in the container; ascertaining a first fill level value based on the first received signal and a second fill level value based on the second received signal; and determining the first fill level value or the second fill level value as fill level when the first fill level value and the second fill level value agree. In this way, the fill level is determined in redundant manner.

The invention relates to a method for safe fill level measurement as well as a radar-based, fill level measuring device for executing such method.

In process automation technology, generally, field devices are applied, which serve for registering or for influencing process variables. For this, the functioning of the field devices is based, in each case, on suitable measuring principles, in order to register the corresponding process variables, such as fill level, flow, pressure, temperature, pH value, redox potential and conductivity. The most varied of such field device types are manufactured and sold by the firm, Endress+Hauser.

For fill level measurement of fill substances in containers, contactless measuring methods have proven themselves, since they are robust and require low-maintenance. In such case, container within the scope of the invention refers also to non-closed containers, such as, for example, vats, lakes or oceans or flowing bodies of water. A central advantage of such measuring methods is their ability to measure the fill level virtually continuously. In the context of the invention, the term radar refers to signals with frequencies between 0.03 GHz and 300 GHz. Usual frequency bands, within which radar-based fill level measurement is executed, lie at 2 GHz, 6 GHz, 26 GHz or 79 GHz. The term optical signal relates to electromagnetic waves having a frequency between 300 GHz (infrared) and 3000 THz (ultraviolet). The term ultrasound relates to acoustic signals having a frequency between 12 kHz and 10 MHz.

In the case of radar- and ultrasonically based fill level measurement, the pulse travel time principle is an established measuring principle. In such case, pulse shaped signals are transmitted cyclically in the direction of the fill substance and the travel time of the pulse shaped received signal is measured. Based on this measuring principle, fill level measuring devices can be implemented with comparatively little circuit complexity.

When in the case of radar-based fill level measurement a more complex circuit technology can be tolerated, fill level measurement can also be performed using FMCW (“Frequency Modulated Continuous Wave”) as measuring principle. This measuring principle rests on transmitting the radar signal continuously, however, with modulated frequency. In such case, the frequency of the signal lies in a fixed frequency band in the region of a standardized center frequency. Characteristic for FMCW is that the transmitting frequency is not constant, but varies periodically within the fixed frequency band. At a center frequency of 79 GHz the frequency band amounts to, for example, 2 GHz, thus, from 78 GHz to 80 GHz. Also in the case of FMCW, the transmitting and receiving of the signals is separated into measuring cycles following one after the other.

The change of frequency as a function of time is linear in the case of FMCW according to standard and has a sawtooth- or triangular shape. A sinusoidal change can, however, also be used in principle. In contrast with the pulse travel time method, the distance, or fill level, in the case of the FMCW method is determined based on the instantaneous frequency difference between the transmitted signal and the current received signal. The measuring principles of FMCW and the pulse travel time method are described, for example, in “Radar Level Detection, Peter Devine, 2000”.

Each of the above mentioned measuring principles, thus each signal type, has advantages and disadvantages. While the use of signals with high bandwidths, thus, high frequencies, means that a potentially higher accuracy of measurement can be achieved, signals with low frequencies tend due to the wider radiation cone to enable fill level determination in the case of sloshing or foaming fill substances. Depending on character of the fill level substance, it can, in turn, occur that the transmitted signal, depending on signal-type (ultrasound, radar or optical), is scattered, absorbed or passed through at the fill substance surface, instead of being reflected as desired.

An object of the invention, therefore, is to provide a method for fill level measurement, with which the fill level can be safely determined independently of boundary conditions.

The invention achieves this object by a method for measuring a fill level of a fill substance located in a container. The method includes, in such case, at least method steps as follows:
transmitting a first signal in the direction of the fill substance,
receiving a corresponding first received signal after reflection of the first signal in the interior of the container,
transmitting a second signal in the direction of the fill substance, wherein the second signal has at least one defined property deviating from the first signal,
receiving a corresponding second received signal after reflection of the second signal in the interior of the container,
determining a first fill level value based on the first received signal and determining a second fill level value based on the second received signal, and
determining the first fill level value or the second fill level value as fill level when the first fill level value and the second fill level value agree.

Because of the method of the invention, the fill level is, thus, redundantly determined. This enables designing the fill level measuring device of interest in conformance with high safety standards (for example, the “Safety Integrity Level 3, SIL3” according to the series of standards IEC61508). Accordingly, in the uncertain case, in which the first fill level value and the second fill level value do not agree, a failure signal can be output.

When the comparison of the two independently ascertained fill level values shows that the first fill level value and the second fill level value do not agree, at least in the case of significant deviation, a difference value can be calculated by subtraction of the first fill level value from the second fill level value. Such a difference value corresponds, in given cases, to the thickness of a single phase of the fill substance or the thickness of a foam layer. Thus, the method of the invention can be applied supplementally, in order to determine such possible, supplemental parameters.

In order to implement the signals to be transmitted with mutually differing properties, different solutions can be used according to the invention. In the simplest case, the second signal can (independently of the signal type of the two signals, thus, radar or ultrasound) be transmitted with a power or a frequency, which differs from the power, or the frequency of the first signal. In such case, the two signals, the first signal and the second signal, can be transmitted, for example, either as radar- or ultrasonic signals.

When the first signal and the second signal are both transmitted as radar signals, to set the different signal properties, however, also the first signal can be transmitted according to the FMCW principle and the second signal according to the pulse travel time principle. Accordingly, in the case of this design, the first fill level value is determined based on the FMCW principle and the second fill level value is determined based on the pulse travel time principle. Instead, a radar signal can be transmitted as first signal, while an ultrasonic signal is transmitted as a second, deviating signal. Another option is given when an optical signal is transmitted as first signal and/or as a second signal. An optical signal can be produced, for example, by means of a laser.

Corresponding to the method, the invention further resides in a radar-based, fill level measuring device for executing those embodiments of the method, which operate based purely on radar signals. This fill level measuring device comprises components as follows:
A signal production unit, which is designed to transmit the first signal and the second signal, in each case, as a radar signal in the direction of the fill substance,
a receiving unit, which is designed to receive after reflection of the first signal and the second signal in the interior of the container corresponding received signals,
an evaluating unit, which is designed
   to ascertain a first fill level value based on the first received signal
   to ascertain a second fill level value based on the second received signal, and
   to output the first or second fill level value as fill level when the first fill level value and the second fill level value agree.

For transmitting the fill level, i.e. the first and/or second fill level value and even a possible failure signal, the fill level measuring device can have a corresponding interface. Alternatively or supplementally, these values can also be displayed on a display of the fill level measuring device.

In reference to the fill level measuring device, “unit” in the context of the invention means, in principle, any electronic circuit, which is suitably designed for the particular purpose of determination. It can, thus, depending on requirement, be an analog circuit for producing, or processing, corresponding analog signals. It can even be a (semiconductor based) digital circuit, such as a microcontroller or a storage medium in cooperation with a program. In such case, the program is designed to perform the corresponding method steps or to apply the necessary calculational operations of the particular unit. In this context, different electronic units of the fill level measuring device can in the sense of invention potentially also use a shared physical memory, or be operated by means of the same physical, digital circuit.

Based on the appended drawing, the invention will now be explained in greater detail. The sole figure of the drawing shows as follows:

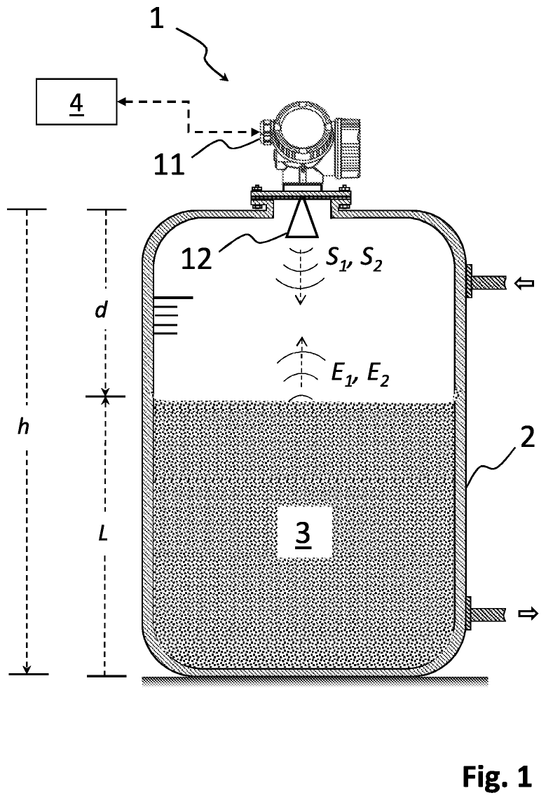

FIG. 1 a typical arrangement of a radar- or ultrasonic based fill level measuring device.

For providing a basic understanding of the invention, FIG. 1 shows a typical arrangement of a radar- or ultrasonically based fill level measuring device 1 mounted on a container 2. Located in the container 2 is a fill substance 3, whose fill level L is to be determined by the fill level measuring device 1. To this end, the fill level measuring device 1 is mounted on the container 2 at a location above the maximum allowable fill level L. Depending on field of application, the installed height h of the fill level measuring device 1 can amount to more than 100 m above the container floor.

As a rule, the fill level measuring device 1 is connectable via an interface 11, which is based on a corresponding bus system, such as, for instance, “Ethernet”, “PROFIBUS”, “HART” or “wireless HART”, to a superordinated unit 4, for example, a process control system, a decentral database or a handheld device, such as a mobile radio device. In this way, on the one hand, information with reference to the operating condition of the fill level measuring device 1 can be communicated. However, also the fill level L can be transmitted via the interface 11, in order, in given cases, to control incoming or outgoing flows of the container 2.

Independently of the implemented measuring principle, the fill level measuring device 1 is so developed that it transmits corresponding signals S₁, S₂ from an antenna 12 in the direction of the fill substance 3. In such case, the signals S₁, S₂ are, depending on signal type (radar, ultrasound) and the implemented measuring method (pulse travel time or FMCW), generated in a corresponding signal production unit of the fill level measuring device 1.

On the surface of the fill substance 3, the transmitted signals S_{1,2} are reflected, so that the corresponding, received signals E_{1,2} are received by a receiving unit of the fill level measuring device 1 after a corresponding signal travel time. The fill level L can be determined from the received signals E_{1,2}, since the signal travel time of the signals S_{1,2}, E_{1,2} depends according to d=h−L on the distance d of the fill level measuring device 1 from the fill substance surface. Accordingly, an evaluating unit of the fill level measuring device 1 designed for this determines the fill level L based on the received signals E_{1,2}.

Depending on character of the fill substance 3 or condition of the fill level measuring device 1, the fill level L can, in given cases, not be determined correctly with sufficient safety, for example, when due to chemical processes in the container 2 a foam formation occurs. Also, an accretion formation on the antenna 12 of the fill level measuring device 1 can, depending on type of the transmitted signal S₁, S₂, prevent a correct fill level measurement. In order that the fill level measuring device 1 can have a high degree of device safety, for example, corresponding to “Safety Integrity Level 3 (SIL3)” conforming to the standard IEC61508, the fill level measuring device 1 must, however, at least be able to output a failure message, when the ascertained fill level L is not valid.

In order to assure this, according to the invention, two signals S₁, S₂ with mutually differing properties are transmitted by the fill level measuring device 1. In such case, it is not relevant within the scope of the invention, whether the first signal S₁ is transmitted simultaneously with, or alternately to, the second signal S₂. Based on each of the two signals S₁, S₂, the fill level measuring device 1 receives separate received signals E₁, E₂, such that, based on each of the at least two different received signals E₁, E₂, separate fill level values are determined. When the first fill level value, which is ascertained based on the first received signal E₁, agrees with the fill level value based on the second received signal E₂, such fill level value is output as valid fill level L. Because of the transmitting of the signals S₁, S₂ of the invention with different properties, the fill level measuring device operates, thus, redundantly. In the unsafe case, when the first fill level value does not agree with the second fill level value, the fill level measuring device 1 can, for example, output a corresponding failure message through the interface 11 or display such on a display.

The deviation of the properties according to the invention between the two signals S₁, S₂ to be transmitted can be achieved in different ways. Thus, for example, the first signal S₁ can be radiated as a radar signal, while the second signal S₂ is transmitted as an ultrasonic signal. The two signals S₁, S₂ can also be transmitted as radar signals, wherein in the case of the first (received-) signal S₁, E₁, and thus for ascertaining the first fill level value, the FMCW method is applied, while the second signal S₂ is transmitted with pulse shape, so that the fill level measuring device 1 ascertains the second fill level value based on the pulse travel time method.

Independently of the implemented signal type or the applied measuring method, the signals S₁, S₂ can, however, also be produced only with differing transmitting powers and/or differing transmitting frequencies, in order to produce redundancy. Another option would be to transmit one of the two signals S₁, S₂ as a laser signal and to ascertain the corresponding fill level value by means of interferometry or another, travel time method.

Based on the method of the invention, the fill level measuring device 1 can, additionally, be supplemented in such a way that it subtracts the fill level value ascertained by the first signal S₁, E₁ from the second fill level value and, as a result, calculates a difference value, when the first fill level value and the second fill level value lie significantly apart. This can be an indicator of foam formation, such that the difference value represents the foam thickness, or an interface thickness between two phases of the fill substance. The ascertained difference value can, in this case, in turn, be output via the interface 11 or a possible display of the fill level measuring device 1.

### LIST OF REFERENCE CHARACTERS

1 fill level measuring device

2 container

3 fill substance

4 superordinated unit

d measured distance

E₁, E₂ received signals

h installed height, or measuring range

L fill level

S₁, S₂ transmitted signals

1-12. (canceled)

13. A method for measuring a fill level of a fill substance in a container, the method comprising:
transmitting a first signal in a direction of the fill substance;
receiving a corresponding first received signal after reflection of the first signal in an interior of the container;
transmitting a second signal in the direction of the fill substance, wherein the second signal has at least one defined property deviating from the first signal;
receiving a corresponding second received signal after reflection of the second signal in the interior of the container;
ascertaining a first fill level value based on the first received signal and ascertaining a second fill level value based on the second received signal; and
determining the first fill level value or the second fill level value as the fill level when the first fill level value and the second fill level value agree.

14. The method as claimed in claim 13, further comprising:
outputting a failure signal when the first fill level value and the second fill level value do not agree.

15. The method as claimed in claim 13, further comprising:
calculating a difference value by subtracting the first fill level value from the second fill level value when the first fill level value and the second fill level value do not agree.

16. The method as claimed in claim 13, wherein the second signal is transmitted with a power that differs from a power of the first signal.

17. The method as claimed in claim 13, wherein the second signal is transmitted with a frequency that differs from a frequency of the first signal.

18. The method as claimed in claim 13, wherein the first signal and the second signal are both radar signals.

19. The method as claimed in claim 18, wherein the first signal is transmitted according to the FMCW principle, and the first fill level value is determined based on the FMCW principle, and wherein the second signal is transmitted according to the pulse travel time principle, and the second fill level value is determined based on the pulse travel time principle.

20. The method as claimed in claim 13, wherein the first signal is transmitted as a radar signal, and wherein the second signal is transmitted as an ultrasonic signal.

21. The method as claimed in claim 13, wherein the first signal and the second signal are both ultrasonic signals.

22. The method as claimed in claim 13, wherein the first signal and/or the second signal are/is optical.

23. A radar-based, fill level measuring device, comprising:
a signal production unit designed to transmit a first signal and a second signal, in each case, as a radar signal in a direction of the fill substance;
a receiving unit designed to receive after reflection of the first signal in an interior of a container, a corresponding first received signal and further designed to receive after reflection of the second signal in the interior of the container, a corresponding second received signal; and
an evaluating unit, configured to:
ascertain a first fill level value based on the first received signal;
ascertain a second fill level value based on the second received signal; and
output the first or second fill level value as the fill level when the first fill level value and the second fill level value agree.

24. The fill level measuring device as claimed in claim 23, further comprising:
an interface by means of which the first fill level value, the second fill level value, and/or the fill level is transmittable.
